(19) United States
(12) Patent Application Publication
(10) Pub. No.: US 2014/0068787 A1
(43) Pub. Date: Mar. 6, 2014

(54) INSTANT ACCOUNT ACCESS AFTER REGISTRATION

(71) Applicant: Uwe Steigmann, Daisbach (DE)

(72) Inventor: Uwe Steigmann, Daisbach (DE)

(73) Assignee: SAP AG, Walldorf (DE)

(21) Appl. No.: 13/596,531

(22) Filed: Aug. 28, 2012

(51) Int. Cl. G06F 21/24

(52) U.S. Cl. 726/28

(57) ABSTRACT

A method for user registration may include in response to receiving registration data of the user from a client, creating an inactivated user account, generating a temporary session that includes a temporary session identification, transmitting the temporary session identification to the client, and subsequent to the transmitting the temporary session identification, sending an e-mail containing a hyperlink for verification to the user.

### FIELD OF THE INVENTION

The present invention is directed to systems and methods for account registration and access, in particular, directed to a system and method for providing instant access to an account after the initial registration by the user.

### BACKGROUND

The first time a user tries to access a secured website (such as an online store), the user is commonly required to go through a registration process. For example, when a first-time user tries to make a purchase from an online store, the user may be requested to register with the store. Thus, in response to activating a registration link by the user, a server of the online store may supply a registration web page to the client computer of the user. The registration page may include fields for the user to fill. For example, the registration page may include a user name field for the user to create a user name, a first password field for the user to enter a password that corresponds to the user name, a second password field for reentering the password to ensure that the first password field was entered correctly, and an e-mail address field for the user to enter an e-mail address to which a verification e-mail may be sent. The registration page may additionally include fields for the user to enter additional data such as name, address, and phone numbers.

After entering information on the registration page, the user may activate a registration button embedded in the registration page to register the user at the server. In response to sending the registration page to the server, an information page may be displayed to remind the user to check for a verification e-mail. Upon receiving the information entered in the registration page, the server may send an e-mail including a verification link to the e-mail address provided by the user. The user may open the e-mail and click on the verification link contained in the e-mail which redirect the user to a login page on which the user may reenter the user name and password pair to activate his account and login to the secured portion of the online store.

### BRIEF DESCRIPTION OF THE DRAWINGS OF THE EXAMPLE EMBODIMENTS

FIG. 1 is a system for instant account registration according to an embodiment of the present invention.

FIG. 2 illustrates a flow diagram of user registration according to an embodiment of the present invention.

FIG. 3 is a process of user registration by a server according to an embodiment of the present invention.

### DETAILED DESCRIPTION OF THE EXAMPLE EMBODIMENTS

The current art requires the first-time user to enter the user name and password pair twice to create and activate a new account, which is cumbersome and inconvenient to the user. It may be desirable to allow the user to access the secured website without the need to enter the user name and password a second time Therefore, there is a need to improve the registration process for accessing an account.

Embodiments of the present invention may include a system and method that enable a first-time user to have instant access to an account without the need to twice enter user name and password pair. In this way, the user experience may be improved while the security of the account is not sacrificed.

Embodiments of the present invention may include a system and method for user registration that may in response to receiving registration data of the user from a client, create an inactivated user account, generate a temporary session that includes a temporary session identification (TSID), transmit the TSID to the client, and subsequent to the transmitting the TSID, send an e-mail containing a hyperlink for verification to the user.

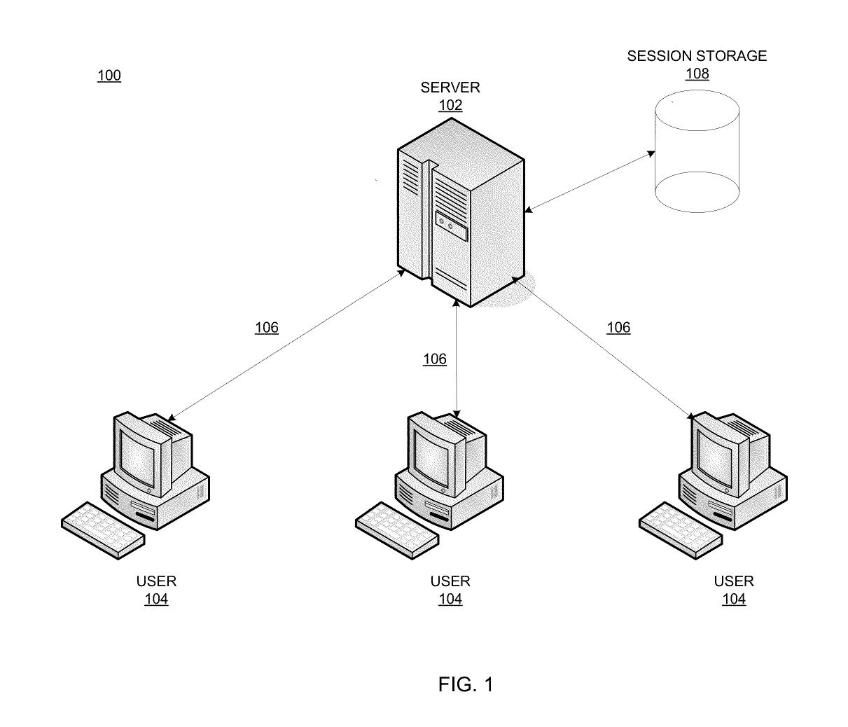

FIG. 1 illustrates a system for user registration according to an embodiment of the present invention. The system 100 may include one or more server 102 which may be in the cloud or on premise. The server 100 may provide certain services (such as secured transactions) to registered users. The registered users may access the service provided by the server 102 using client devices 104 through network connection 106. The client devices 104 may include desktop computers, mobile computers, tablet computers, or smart phones. In one embodiment, the server 102 and client 104 may interact through sessions. The server 102 may include a processor that is configured to execute a session manager for tracking the user's activities across sessions. The system 100 may also include a session storage 108 that may be coupled to server 102 for storing sessions.

In one embodiment, the server 102 may be a web server that client 104 running a web browser may interact based on Hypertext Transfer Protocol (HTTP) which is stateless. Thus, the client 104 running the web browser may establish network connection to the server 102 with HTTP GET or POST requests. The session manager may create or retrieve corresponding sessions from the session storage 108 for the GET or POST requests. Thus, once the user is authorized to access the web server, the user may not be asked for authentication with respect to further HTTP GET or POST requests from client 104. Each session as stored in the session storage 108, may be a data object that may include a session ID and the associated session data such as a key for enabling the client to securely access to the server.

A first-time user of the services provided by the server may need to register to become a registered user. As discussed above, current art requires the user to enter twice user name and password pair for verification purpose, and is therefore cumbersome and inconvenient to the user. Embodiments of the present invention may register and verify a user using a temporary short-term session so that the user may not need to enter the user name and password pair a second time.

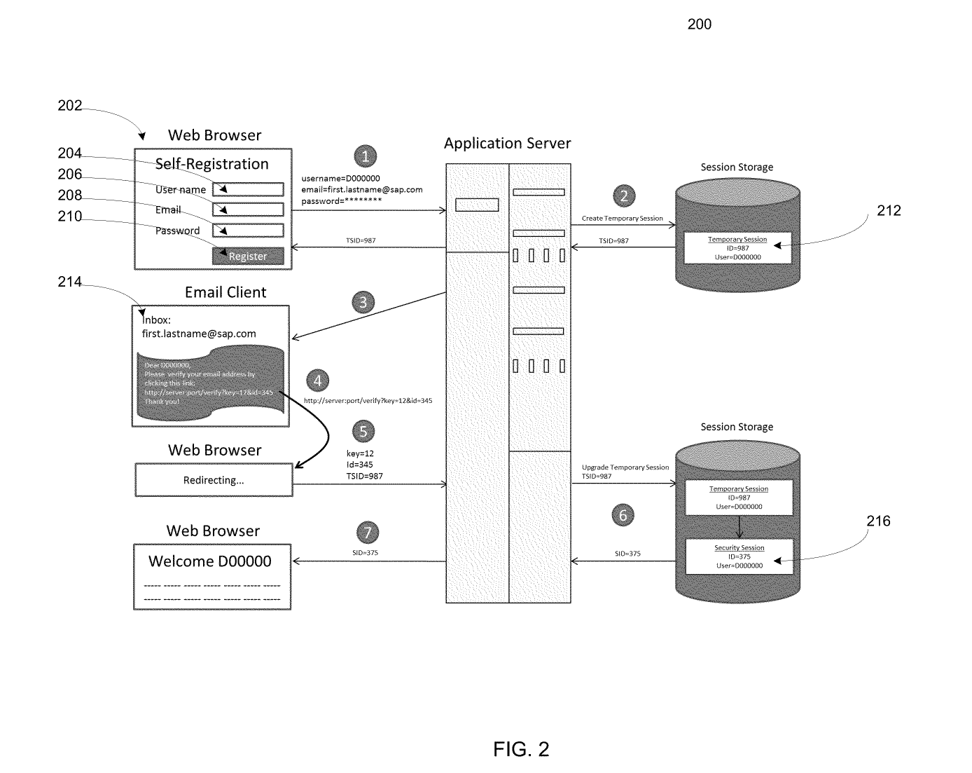

FIG. 2 illustrates a flow diagram of user registration according to an embodiment of the present invention. In response to the user activating a registration link, the server 102 may supply client device 104 through a browser with a registration page 202 that may be displayed to the user on the client device 104. The registration page 202 may include a first field 204 for entering a user name, a second field 206 for entering an e-mail address for receiving the verification e-mail, and a third field 208 for entering password selected by the user. The registration page 202 may optionally include other fields for reentering the password, address information, and other personal information. Further, the registration page 202 may include an actionable element 210 (such as a push button) which, when activated, may cause the client to transmit the registration data including the user name, e-mail address, and password to the server 102.

In response to receiving the registration data, the server 102 may create an account for the user. After creation, the created account is temporarily disabled (or, in an inactivate state) until further verification. In response to the creation of the account, the server may execute the session manager to generate a temporary session 212 that may have a limited life time. In one embodiment, the temporary session 212 may have a life time of a few minutes. In an embodiment, the life time of the temporary session 212 is no more than 10 minutes. In another embodiment, the life time of the temporary session 212 is no more than 5 minutes. The temporary session may be a data object that may include an identifier (TSID) that may be associated with the user account. The server 102 may also generate a random key and store the random key together with the user's data Server 102 may store the generated temporary session 212 in the session storage 108.

In response to the generation of the temporary session, the server 102 may transmit the TSID to the client 104. In an embodiment, the client 104 may support a web browser so that the TSID may be stored as an HTTP cookie on the client 104. Alternatively, the TSID may be stored in an HTTP header file.

Subsequent to the transmission of the TSID to the client, the server 102 may send a verification e-mail 214 to the e-mail address that had been provided by the user during the registration step. The verification e-mail 214 may contain information about the initial registration and a hyperlink that may be embedded with parameters. The hyperlink may point to the server 102, and the embedded parameters may reference, either directly or indirectly, to the user account that had been created for the user for this registration. In one embodiment, the parameter may include the random key that may be used by the server 102 to verify validity of the registration by matching the transmitted key against the random key that had been stored together with the user data on the server. In an embodiment, the hyperlink may be an HTML link that may redirect the user to the server 102.

After the user opens the e-mail 214 and clicks on the hyperlink contained therein, the client 102 may open a new browser instance. In an embodiment, the new browser instance may be a new web page in the same browser that was used for the registration. Alternatively, the new browser instance may be a new, separate browser. In response to the opening of the new browser instance, the TSID stored in the cookie on the client 104 may be retrieved. The TSID along with the embedded parameters contained in the clicked-on hyperlink may be transmitted to the server 102. Thus, the server 102 may receive the TSID, user ID, and the random key for verification.

Upon receiving these data, the server 102 may check whether the received data are valid by comparing the received key against the random key stored together with the user data. If the keys match each other, i.e., the received data are valid, the server 102 may activate the user account. The server 102 may further determine whether the temporary session is a valid session based on the received TSID. If the account and the temporary session are both valid, the server may upgrade the temporary session to a secured session 216 and associate the secured session 216 to the user account which had already been activated. For security reasons, the server 102 may assign a new and different session identification to the new secured session.

After the user account is activated and assigned a secured session, the server 102 may allow the user to log in and access the secured content on the client 104. Therefore, the user may start accessing the content on the server right away without the extra step of second login. Without the second login step, the user experience may be improved.

However, if client 104 did not provide valid data to the server 102 when the user clicked on the hyperlink, server 102 may not activate the user account. Instead, the server 102 may inform client 104 that the credentials provided by the client 104 are invalid. In another scenario, if the server 104 determines that the data provided by the client 104 is valid, but that the temporary session has become invalid (for example, the life time of the temporary session has expired because the user clicked on the hyperlink too late), the server 102 may send the client 104 a login page to require the user to reenter the user name and password pair for authentication. If the user successfully authenticates by entering the correct user name and password, the server 104 may allow the user to access the secured content on the server.

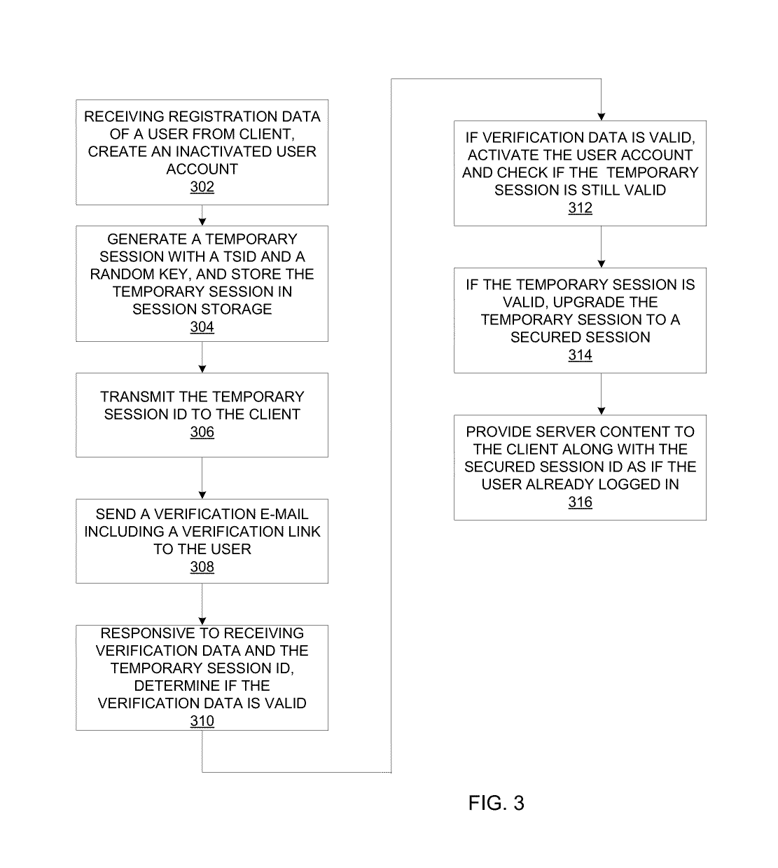

FIG. 3 is a process of user registration as executed on the server 102 according to an embodiment of the present invention. At 302, the sever may receive registration data entered by a first-time user from a client for the purpose of registering at the server and accessing content stored on the server. The registration data may include the user name, password created by the user, and an e-mail address for receiving verification information. In response to receiving the registration data, the server may create a user account based on the registration data. Since the user has not been verified, the user account, although created, is not activated.

At 304, in response to receiving the registration data, the server may execute a session manager to generate a temporary session identified by a temporary session identification (TSID) and store the temporary session in a session storage. The temporary session may be a data object that may be retrieved based on the TSID. Further, the temporary session may have limited, pre-specified life time after which the temporary session may become invalid. Additionally, the server may generate a random key and store the random key together with the user's data. The random key may be used for later data validation. In one embodiment, the random key a string of alphabets and digits.

At 306, the server may transmit the TSID to the client and store the TSID on the client. The TSID may be stored in an HTTP cookie. Subsequent to the transmission of the TSID, at 308, the server may send a verification e-mail to the user's e-mail address. The verification e-mail may include information about the registration and a hyperlink for verification. The hyperlink may be embedded with parameters that may reference the user account. The parameters may include the random key that had been generated for validation.

The user may read the e-mail and click on the hyperlink contained in the verification e-mail. In response to the activation of the hyperlink by the user, the client may transmit verification data to the server. The verification data may include the TSID stored in the cookie and a user identification. The verification data may also include the random key. At 310, in response to receiving the verification data at the server and the TSID, the server may determine whether the verification data is valid. In one embodiment, the server may retrieve the user data based on the user ID, and compare the received random key against the stored random key. The user data is deemed valid if the received random key matches the stored random key.

If the verification data is valid, at 312, the server may convert the user account from an inactive state to an active state. Further, the server may check whether the temporary session identified by the TSID is still valid.

If the temporary session identified by the TSID is valid, at 314, the server may upgrade the temporary session to a secured session and associate the activated user account with the secured session. In this way, the user has been securely verified and is ready for accessing the content on the server. Therefore, at 316, the server may provide content to the client along with the secure session ID as if the user already logged in. As such, the user may not need to reenter the user name and password pair for verification.

However, if the verification data were invalid, the server may not activate the user account. Instead, the server may inform the client that the user's credentials are incorrect. On the other hand, if the verification data were valid, but the temporary session was invalid (for example, because its life has expired), the server may provide a login page to the client on which the user may reenter the user name and password pair to authenticate.

Although the present invention has been described with reference to particular examples and embodiments, it is understood that the present invention is not limited to those examples and embodiments. Further, those embodiments may be used in various combinations with and without each other. The present invention as claimed therefore includes variations from the specific examples and embodiments described herein, as will be apparent to one of skill in the art.

1. A computer-implemented method for registration of a user, comprising:
in response to receiving registration data of the user from a client, creating, by a processor, an inactivated user account;
generating, by the processor, a temporary session that includes a temporary session identification;
transmitting, by the processor, the temporary session identification to the client;
subsequent to the transmitting the temporary session identification, sending, by the processor, an e-mail containing a hyperlink for verification to the user; and
receiving validation data and the temporary session identification from the client based on which a determination is made as to whether to activate the user account and allow the user directly log into the account.

2. The method of claim 1, further comprising:
determining if the validation data is valid;
if the validation data is valid,
activating the user account;
determining if the temporary session is valid;
if the temporary session is valid,
upgrading the temporary session to a secured session;
associating the secured session with the user account; and
supplying the client with contents;
if the temporary session is invalid,
supplying the client with a login page; and
if the validation data is invalid,
informing the user that credentials provided by the user are invalid.

3. The method of claim 1, wherein the registration data include a user name, a password, and an e-mail address of the user.

4. The method of claim 1, wherein the temporary session is a data object stored in a session storage that is coupled to the server.

5. The method of claim 1, wherein the user activates the hyperlink for account verification, causing the client to transmit the verification data to the server.

6. The method of claim 1, wherein the temporary session has a limited life time beyond which the temporary session becomes invalid.

7. The method of claim 6, wherein the life time of the temporary session is no more than 10 minutes.

8. The method of claim 1, further comprising:
generating a random key;
storing the random key together with the user's data; and
sending the random key as a parameter in the hyperlink to the user.

9. The method of claim 8, further comprising:
receiving verification data and the temporary session identification from the client;
comparing verification data with the stored random key.

10. A system for registration of a user, comprising:
a processor configured to:
in response to receiving registration data of the user from a client, create an inactivated user account;
generate a temporary session that includes a temporary session identification;
transmit the temporary session identification to the client;
subsequent to the transmitting the temporary session identification, send an e-mail containing a hyperlink for verification to the user; and
receive validation data and the temporary session identification from the client based on which a determination is made as to whether to activate the user account and allow the user directly log into the account.

11. The system of claim 10, wherein the processor is further configured to:
determine if the validation data is valid;
if the validation data is valid,
activate the user account;
determine if the temporary session is valid;
if the temporary session is valid,
upgrade the temporary session to a secured session;
associate the secured session with the user account; and
supply the client with contents;
if the temporary session is invalid,
supply the client with a login page; and
if the validation data is invalid,
inform the user that credentials provided by the user are invalid.

12. The system of claim 10, wherein the registration data include a user name, a password, and an e-mail address of the user.

13. The system of claim 10, wherein the temporary session is a data object stored in a session storage that is coupled to the server.

14. The system of claim 10, wherein the user activates the hyperlink for account verification, causing the client to transmit the verification data to the server.

15. The system of claim 10, wherein the temporary session has a limited life time beyond which the temporary session becomes invalid.

16. The system of claim 15, wherein the life time of the temporary session is no more than 10 minutes.

17. The system of claim 10, wherein the processor is further configured to:
generate a random key;
store the random key together with the user's data; and
send the random key as a parameter in the hyperlink to the user.

18. The system of claim 17, wherein the processor is further configured to:
receive verification data and the TSID from the client;
compare verification data with the stored random key.

19. A machine-readable non-transitory medium having stored thereon machine-executable codes that, when executed, perform a method for registration of a user, the method comprising:
in response to receiving registration data of the user from a client, creating an inactivated user account;
generating a temporary session that includes a temporary session identification;
transmitting the temporary session identification to the client; and
subsequent to the transmitting the temporary session identification, sending an e-mail containing a hyperlink for verification to the user;
receiving verification data and the temporary session identification from the client;
determining if the validation data is valid;
if the validation data is valid,
activating the user account;
determining if the temporary session is valid;
if the temporary session is valid,
upgrading the temporary session to a secured session;
associating the secured session with the user account; and
supplying the client with contents;
if the temporary session is invalid,
supplying the client with a login page; and
if the validation data is invalid,
informing the user that credentials provided by the user are invalid.

20. The machine-readable medium of claim 19, wherein the registration data include a user name, a password, and an e-mail address of the user.
